(19) United States
(12) Patent Application Publication
(10) Pub. No.: US 2018/0276655 A1
(43) Pub. Date: Sep. 27, 2018

(54) SHARED MOBILE WALLET TRANSACTION

(71) Applicant: CA, Inc., Islandia, NY (US)

(72) Inventors: Yashwant Ramkishan Sawant, Maharastra (IN); Mohammed Mujeeb Kaladgi, Bangalore (IN); Sandeep Banisetti, Andhra Pradesh (IN); Ruqiya Nikhat Kaladgi, Bangalore (IN)

(21) Appl. No.: 15/466,805

(22) Filed: Mar. 22, 2017

(51) Int. Cl. G06Q 20/36; G06Q 20/32

(52) U.S. Cl. CPC G06Q 20/367; G06Q 20/3278

(57) ABSTRACT

Aspects of the embodiments are directed to methods, systems, and computer program products for shared mobile wallet transactions. In embodiments, a mobile device can transmit a shared mobile wallet transaction request message to a mobile device operated by a shared mobile wallet contributor across a network connection; receive, from the shared mobile wallet contributor, a wallet transaction packet, the wallet transaction packet comprising a monetary contribution value and an identifier of the shared mobile wallet contributor; create a shared mobile wallet transaction packet comprising a monetary contribution value for the user, an identifier of the user, the monetary contribution value for the shared mobile wallet contributor, and an identifier of the shared mobile wallet contributor; and transmit the shared mobile wallet transaction packet to a point of sale device across a communications link. The communications link can be a near-field communications link.

### FIELD

This disclosure pertains to sharing mobile wallet transactions between multiple payors.

### BACKGROUND

Near-frequency communications can be used for paying for transactions using a mobile device, such as a smartphone or wearable device. Near-field Communications (NFC) is a short-range high frequency wireless communication technology commonly used in contactless cards, mobile phones and passive RFID. Mobile payment applications include retail, public transportation ticketing and interactive advertising.

### SUMMARY

Aspects of the embodiments include a method performed on a mobile device for performing a shared mobile wallet transaction for a user and one or more shared mobile wallet contributors, the method including transmitting a shared mobile wallet transaction request message to a mobile device operated by a shared mobile wallet contributor across a network connection; receiving, from the shared mobile wallet contributor, a wallet transaction packet, the wallet transaction packet including a monetary contribution value and an identifier of the shared mobile wallet contributor; creating a shared mobile wallet transaction packet including a monetary contribution value for the user, an identifier of the user, the monetary contribution value for the shared mobile wallet contributor, and an identifier of the shared mobile wallet contributor; and transmitting the shared mobile wallet transaction packet to a point of sale device across a communications link.

In some embodiments, transmitting the shared mobile wallet transaction packet to a point of sale device across a communications link includes transmitting the shared mobile wallet transaction packet to the point of sale device across a near-field communication link.

In some embodiments, the received mobile wallet transaction packet further includes a replenishment key associated with the shared mobile wallet contributor and a hash of the monetary contribution value for the shared mobile wallet contributor and the replenishment key.

In some embodiments, the received mobile wallet transaction packet further includes banking information associated with the shared mobile wallet contributor.

In some embodiments, the shared mobile wallet transaction packet includes an International Organization for Standardization (ISO) 8583 compliant packet.

In some embodiments, the method can also include identifying the one or more shared mobile wallet contributors from a contacts list on the mobile device; and wherein transmitting a shared mobile wallet transaction request message to a mobile device operated by a shared mobile wallet contributor across a network connection includes transmitting the shared mobile wallet transaction request to one or more shared mobile wallet contributors from the contacts list.

In some embodiments, receiving, from the shared mobile wallet contributor, a wallet transaction packet, the wallet transaction packet including a monetary contribution value and an identifier of the shared mobile wallet contributor includes receiving the wallet transaction packet from across a near-field communication link.

In some embodiments, the receiving, from the shared mobile wallet contributor, a wallet transaction packet, the wallet transaction packet including a monetary contribution value and an identifier of the shared mobile wallet contributor includes receiving the wallet transaction packet from across a network connection.

Aspects of the embodiments include a computer program product including a computer readable storage medium including computer readable program code embodied therewith. The computer readable program code including computer readable program code configured to broadcast, from an initiating mobile device, a shared mobile wallet transaction request message to a contributing mobile device; computer readable program code configured to receive from the contributing mobile device a mobile wallet transaction message including a transaction amount and an identifier of a user of the contributing mobile device; computer readable program code configured to create a shared mobile wallet transaction message including a transaction amount and identifier for a user of the initiating mobile device and the transaction amount and identifier of the user of the contributing mobile device; and computer readable program code configured to transmit the shared mobile wallet transaction message to a point of sale device across a near-field communications link.

In some embodiments, the computer readable program code configured to create a shared mobile wallet transaction message also includes computer readable program code to add a replenishment key associated with the contributing mobile device and a hash of the transaction amount and the replenishment key for the contributing mobile device to the shared mobile wallet transaction message.

In some embodiments, the received wallet transaction message further includes banking information associated with the shared mobile wallet contributor.

In some embodiments, the shared mobile wallet transaction message includes an International Organization for Standardization (ISO) 8583 compliant packet.

In some embodiments, the computer readable program includes computer readable program code configured to identifying the one or more shared mobile wallet contributors from a contacts list on the mobile device; and wherein computer readable program code configured to transmit a shared mobile wallet transaction request message to the contributing mobile device op across a network connection includes computer readable program code configured to transmit the shared mobile wallet transaction request to one or more contributing mobile devices from the contacts list.

In some embodiments, the computer readable program code is configured to receive a mobile wallet transaction packet from the contributing mobile device includes computer readable program code to receive the mobile wallet transaction packet from across a near-field communication link.

In some embodiments, the computer readable program code is configured to receive a mobile wallet transaction packet from the contributing mobile device includes computer readable program code to receive the mobile wallet transaction packet from across a network connection.

Aspects of the embodiments include a method performed on a mobile wallet transaction server, the method including receiving, from a point of sale device, a shared mobile wallet transaction packet including a monetary contribution value for a plurality of mobile wallet transaction contributors and an identifier of each mobile wallet transaction contributor; identifying, from the shared mobile wallet transaction packet, a first mobile wallet transaction contributor and a monetary contribution value for the first mobile wallet transaction contributor; identifying from the shared mobile wallet transaction packet a second mobile wallet transaction contributor and a monetary contribution value for the second mobile wallet transaction contributor; transmitting a mobile wallet payment request including the monetary contribution value to a payment processing server for the first mobile wallet transaction contributor; and transmitting a mobile wallet payment request including the monetary contribution value to a payment processing server for the second mobile wallet transaction contributor.

In some embodiments, the method also includes determining that the mobile wallet payment processor for the first mobile wallet transaction contributor and the payment processing server for the second mobile wallet transaction contributor are the same payment processing server; and transmitting the shared mobile wallet transaction packet to the same payment processing server.

In some embodiments, receiving, from a mobile device, a shared mobile wallet transaction packet includes receiving, from a mobile device, a shared mobile wallet transaction packet from a near field communications link.

In some embodiments, identifying the first mobile wallet transaction contributor includes identifying banking information for the first mobile wallet transaction contributor and identifying a payment processing server associated with the banking information.

In some embodiments, the shared mobile wallet transaction packet is compliant with an ISO8583 standard.

In some embodiments, the method also includes transmitting to a payment processing server an MD5 hash of the first mobile wallet transaction contributor and a monetary contribution value.

In some embodiments, the method also includes transmitting to a payment processing server an MD5 hash of a replenishment key and a monetary contribution value associated with a contributor.

Advantages of the present disclosure are readily apparent to those of skill in the art. Among the advantages are:

Only one request is performed on the user end to perform payment and split a bill.

Merchant information, such as the merchant name, ID, etc. will not be repeated, as would be the case if several individual transactions were made.

If POS is modified, then the existing with payment protocol shared transactions can be made across different issuers. For example, the POS can parse the ISO8583 message to identify multiple issuers, and request payment be made by each one.

### BRIEF DESCRIPTION OF THE DRAWINGS

FIG. 1 is a schematic block diagram of an example system for sharing mobile wallet transactions in accordance with embodiments of the present disclosure.

FIG. 2 is a schematic diagram of an example shared mobile wallet transaction packet in accordance with embodiments of the present disclosure.

FIG. 3 is a process flow diagram for a mobile device for creating a shared mobile wallet transaction packet in accordance with embodiments of the present disclosure.

FIG. 4 is a process flow diagram for a contributing mobile device to respond to a shared mobile wallet transaction packet request message in accordance with embodiments of the present disclosure.

FIG. 5 is a process flow diagram for a point of sale device for processing a shared mobile wallet transaction packet in accordance with embodiments of the present disclosure.

FIG. 6 is a process flow diagram for a shared payment processor to process a shared mobile wallet transaction packet.

### DETAILED DESCRIPTION

In a group setting, a mobile wallet transaction can be used by a mobile device to pay for a group of people. A payor member of the group can pay for the entire group, while other members of the group can repay the payor. This disclosure describes a way to perform a shared transaction by taking a ISO8583 packet from each contributing element and performing a single transaction.

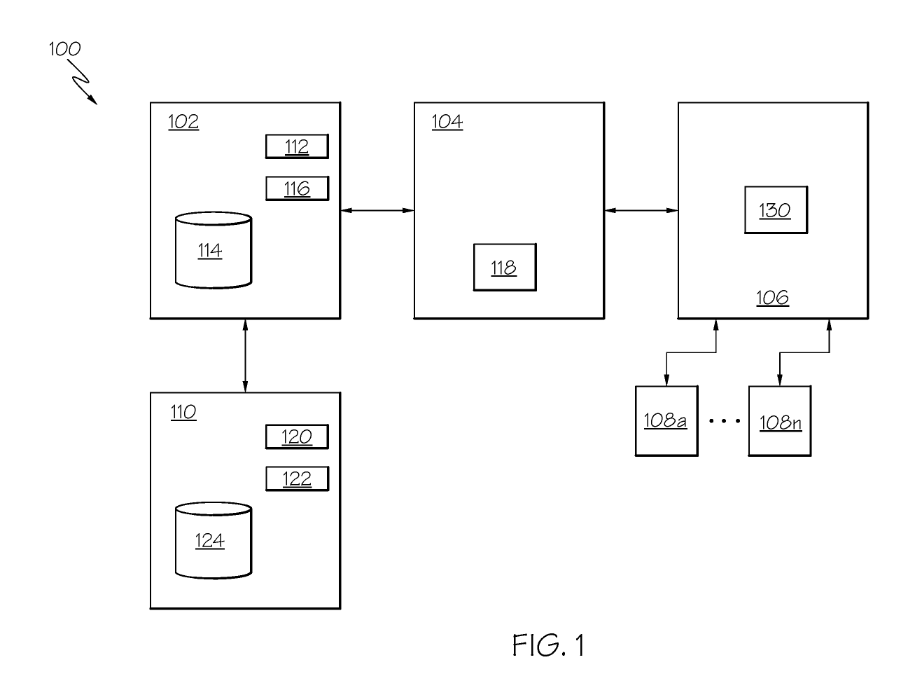

FIG. 1 is a schematic block diagram of an example system 100 for sharing mobile wallet transactions in accordance with embodiments of the present disclosure. System 100 includes an initiating mobile device 102. The initiating mobile device 102 can be a mobile phone, a smartphone, table, or other mobile computing device that can communicate with other devices across a network connection, Bluetooth connection, Wi-Fi connection, and/or a near-field communications (NFC) connection. The initiating mobile device 102 can include a processor 112, such as a hardware processor. The initiating mobile device 102 can also include a memory 114. Memory 114 can store information, such as banking information, a contacts list, credit card information, mobile applications, and other information. In embodiments, memory 114 can store a mobile wallet application to allow a user to engage in shared mobile wallet transactions (as well as mobile wallet transactions that are not shared). The initiating mobile device 102 can also include a transceiver 116. Transceiver 116 can be configured to transmit and receive data packets. The transceiver 116 can be a near-field communications transceiver, a radio transceiver, Wi-Fi transceiver, or combination of all three.

In embodiments, the initiating mobile device 102 can initiate a shared mobile wallet transaction by transmitting (or broadcasting) a shared mobile wallet transaction request message to one or more contributing mobile devices, such as mobile device 110. The contributing mobile device 110 can be a mobile phone, a smartphone, table, or other mobile computing device that can communicate with other devices across a network connection, Bluetooth connection, Wi-Fi connection, and/or a near-field communications (NFC) connection. The contributing mobile device 110 can include a processor 120, such as a hardware processor. The contributing mobile device 110 can also include a memory 124. Memory 124 can store information, such as banking information, a contacts list, credit card information, mobile applications, and other information. In embodiments, memory 124 can store a mobile wallet application to allow a user to engage in shared mobile wallet transactions (as well as mobile wallet transactions that are not shared). The contributing mobile device 110 can also include a transceiver 122. Transceiver 122 can be configured to transmit and receive data packets. The transceiver 122 can be a near-field communications transceiver, a radio transceiver, Wi-Fi transceiver, or combination of all three.

Upon receiving a shared mobile wallet request message from the initiating mobile device 102, the contributing mobile device 110 can create an ISO8583 mobile wallet transaction packet that includes: 1) an amount (monetary transaction value) each user wants to contribute; 2) 1 replenishment key; 3) an MD5 hash of amount and replenishment key; and 4) other transaction related information, such as identification information, banking information, credit card number, etc. In embodiments, each mobile wallet will have two sets of the replenishment keys: Set 1 will be used by a wallet application on a mobile device for the regular transactions from the walled application; and Set 2 will be used in a shared transaction.

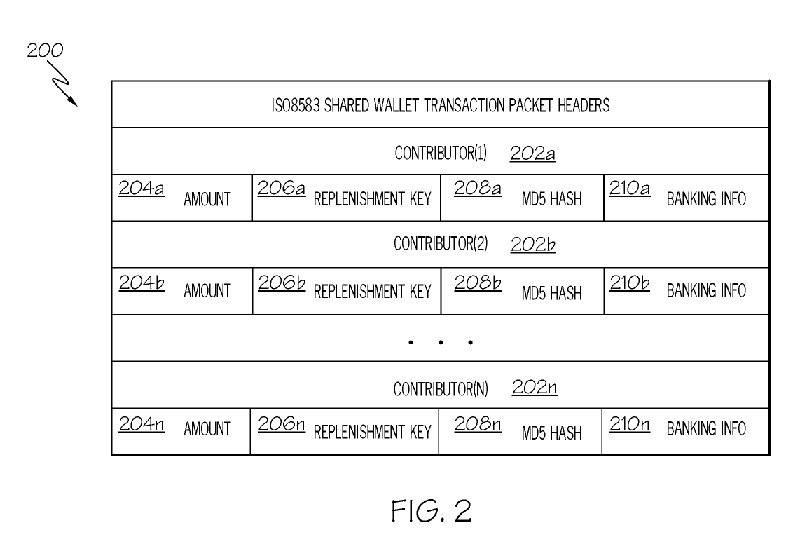

The contributing mobile device 110 can transmit the mobile wallet transaction packet to the initiating mobile device 102. The initiating mobile device 102 can create a shared transaction ISO8583 packet containing information about each contributing user's transaction. FIG. 2 is a schematic diagram of an example shared mobile wallet transaction packet 200 in accordance with embodiments of the present disclosure. The shared mobile wallet transaction packet 200 can be compliant with the ISO8583 packet and can include one or more of the elements 1)-4) described above.

The shared mobile wallet transaction packet 200 can include a field for an identifier for the first contributor 202a. The first contributor 202a can be the initiator of the shared mobile wallet transaction. The packet 200 can include a field for an amount of the transaction 204a for the first contributor, a shared mobile wallet transaction replenishment key 206a for the first contributor, an MD5 hash 208a of the amount 204a and the replenishment key 206a for the first contributor, and banking information for the first contributor, such as credit card information, banking information, etc. The shared mobile wallet transaction packet 200 can include a field for an identifier for the second contributor 202b. The packet 200 can include a field for an amount of the transaction 204b for the second contributor, a shared mobile wallet transaction replenishment key 206b for the second contributor, an MD5 hash 208b of the amount 204b and the replenishment key 206b for the second contributor, and banking information 208b for the second contributor, such as credit card information, banking information, etc. The shared mobile wallet transaction packet 200 can include a field for an identifier for a plurality of contributors, denoted as the nth contributor (contributor(n)) 202n. The packet 200 can include a field for an amount of the transaction 204n for the nth contributor, a shared mobile wallet transaction replenishment key 206n for the nth contributor, an MD5 hash 208n of the amount 204n and the replenishment key 206n for the nth contributor, and banking information 208n for the nth contributor, such as credit card information, banking information, etc.

Returning to FIG. 1, the system 100 can also include a point of sale (PoS) device 204. Point of sale device 204 can receive mobile wallet transaction packets from a mobile device and process the mobile wallet transaction packet to process payment. The point of sale device 204 can include an NFC terminal that can receive an ISO8583 compliant packet from a mobile device from across a near-field communications (NFC) link.

The shared mobile wallet transaction packet 200 can be transmitted by the initiating mobile device 102 to a point of sale (POS) device 104 through the NFC link, such as by tap and pay mobile wallet transaction protocols.

The POS device 104 can include a processor 118 that can be configured to process a shared mobile wallet transaction packet. The processor 118 can be hardware processor that executes computer program product code. The processor 118 can be referred to as a shared transaction processor 118 and can be configured to separate each individual transaction contributor from the shared mobile wallet transaction packet 200. In embodiments, the POS device 104 can create individual transaction packets (e.g., packets also compliant with ISO8583) for each contributor in the shared mobile wallet transaction packet 200. The POS 104 can transmit each transaction individually to mobile wallet payment processor 106. The mobile wallet payment processing processor 106 can then send each individual mobile wallet transaction packets to one or more issuers 108a-108n for payment processing. The mobile wallet payment processor can be a processing server that resides with the point of sale device/terminal (e.g., a processor within the PoS device) or the mobile wallet transaction processor can be a remote processor or server that is associated with an issuer of a payment.

In embodiments, the POS device 104 can transmit the entire shared mobile wallet transaction packet 200 to the mobile wallet payment processor 106. The mobile wallet payment processor 106 can include a shared transaction processor 130, which can identify each contributor from the packet 200 and send individual mobile wallet transaction packets to one or more payment issuers 108a-108n.

In embodiments, the POS device 104 can send the MD5 hash of the received message to an issuer 108a-108n as protection against tampering. The issuer 108a-108n can then execute the payment of the transaction.

The ISO8583 message transfer from user's friend to user can be protected by SSL.

In embodiments, the (ISO8583-compliant) shared mobile wallet transaction packet 200 in above case can be transmitted using the internet or broadband connection using SSL.

If the contributor device 110 that is contributing an amount is local to the initiating mobile device 102, then the two mobiles 102 and 110 can use NFC tap of two mobiles to transfer the ISO8583 packet 200. This use of NFC tap can reduce the SSL requirement and will eliminate other network security issues. Instead of NFC, Bluetooth or Wi-Fi can be used to communicate ISO8583 messages.

In some embodiments, the initiating mobile device 102 and the one or more contributing mobile devices 110 can use a bank card from the same issuer. The initiating mobile device 102 will collect necessary details from all the involved contributors The initiating mobile device 102 creates a shared transaction with its banking details as the main transaction and other contributor's details in private fields of ISO8583 packet 200. The POS device 104 will process this transaction as regular transaction and using the master card number, and will transmit the ISO5853 packet 200 to the respective master bank (e.g., issuer 108a). The bank will recognize this ISO8583 packet 200 as shared transaction packet and isolate all contributor's details from the private fields. Now bank will process each of the contributor's details as a separate transaction.

Near Field Communication (NFC) is a short-range wireless connectivity standard (Ecma-340, ISO/IEC 18092) that uses magnetic field induction to enable communication between devices when they're touched together, or brought within a few centimeters of each other. Jointly developed by Philips and Sony, the standard specifies a way for the devices to establish a peer-to-peer (P2P) network to exchange data. After the P2P network has been configured, another wireless communication technology, such as Bluetooth or Wi-Fi, can be used for longer range communication or for transferring larger amounts of data.

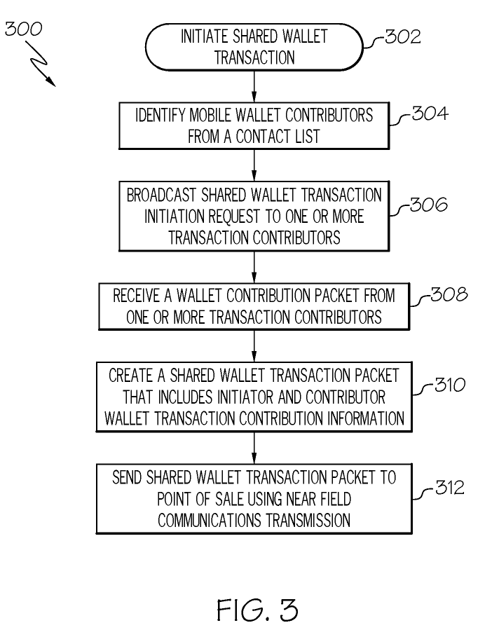

FIG. 3 is a process flow diagram 300 for a mobile device for creating a shared mobile wallet transaction packet in accordance with embodiments of the present disclosure. At the outset, and initiating mobile device can initiate a shared mobile wallet transaction through, e.g., a wallet application on the mobile device (302). The initiating mobile device can identify from a contacts list or a friends list one or more contributing mobile devices (304). The initiating mobile device can transmit a shared mobile wallet transaction request message (306). The transmission can be a broadcast transmission, Bluetooth transmission, NFC transmission, or other communications links. In embodiments, the contributing mobile devices can activate a mobile wallet application to configure a mobile wallet transaction packet without receiving a request message (e.g., users can ask that contributors configure a mobile wallet transaction message orally).

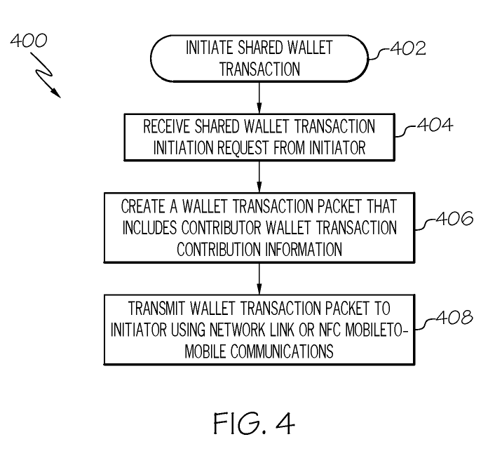

Turning briefly to FIG. 4, FIG. 4 is a process flow diagram 400 for a contributing mobile device to respond to a shared mobile wallet transaction packet request message in accordance with embodiments of the present disclosure. The contributing mobile device(s) can request a shared mobile wallet transaction request message (404). The contributing mobile device(s) can create a mobile wallet transaction message (e.g., a message compliant with the ISO8583 protocols) (406). The mobile wallet transaction message can include the contributor's identification, a contribution amount, banking information, etc. The contributing mobile device(s) can transmit the ISO8583 packet to the initiating mobile device (408). Such transmission can be done through a radio connection, network connection, Wi-Fi connection, Bluetooth connection, or NFC link (e.g., by tapping the mobile devices together to transmit the packet).

In embodiments where the contributing mobile device(s) can prepare a mobile wallet transaction packet without receiving a request from an initiator, the contributing mobile device(s) can launch a mobile wallet application, prepare a mobile wallet transaction packet, and transmit the packet to the initiator.

Returning to FIG. 3, the initiating mobile device can receive a mobile wallet transaction message from one or more contributing mobile devices (308). The initiating mobile device can create a shared mobile wallet transaction packet that includes the initiator's identifier, contribution amount, and banking details, as well as identifiers, contribution amounts, and banking details of each contributor (310). The initiating mobile device can then transmit the shared mobile wallet transaction packet to the point of sale device (POS device) via NFC link (312).

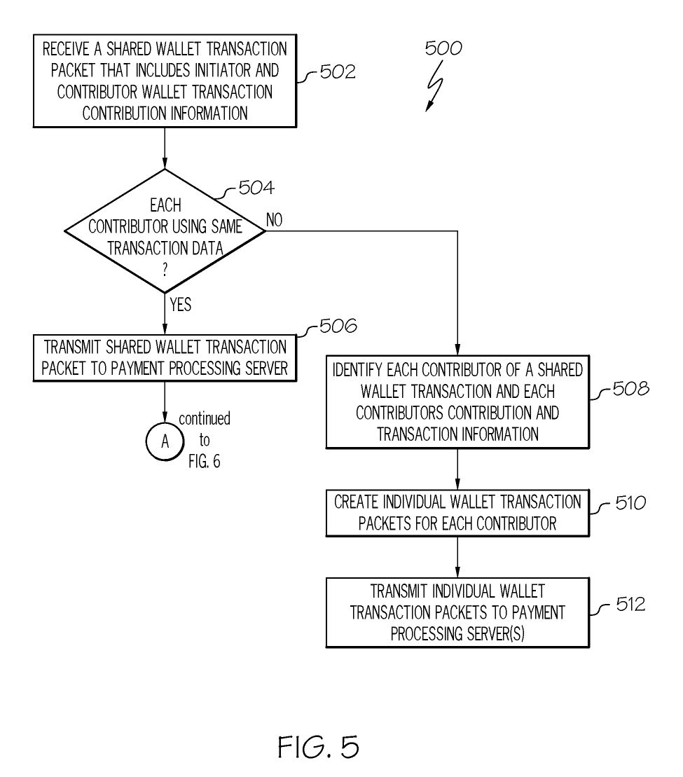

FIG. 5 is a process flow diagram 500 for a mobile wallet transaction processor for processing a shared mobile wallet transaction packet in accordance with embodiments of the present disclosure. The mobile wallet transaction processor can be a processing server that resides with the point of sale device/terminal (e.g., a processor within the PoS device) or the mobile wallet transaction processor can be a remote processor or server that is associated with an issuer of a payment. The mobile wallet transaction server can receive (e.g., from a point of sale device or from a bile device) a shared mobile wallet transaction packet (502). The mobile wallet transaction server can determine from the shared mobile wallet transaction packet whether each contributor is using a credit card issued by a common issuer (504). If each contributor is using a credit card issued by a common issuer, then the mobile wallet transaction server can transmit the shared mobile wallet transaction packet to the issuer for payment processing (506). The issuer would use a shared transaction processor to identify each contributor from the shared mobile wallet transaction packet, as well as each contributors contribution amount and banking details to process payment. The mobile wallet transaction server can send in the shared mobile wallet transaction packet a hash of the contribution amount and replenishment key for added security.

If each contributor is not using a credit card issued by a common issuer, then the mobile wallet transaction server can identify from the shared mobile wallet transaction packet each contributor, each contributors' contribution amount, and banking details (508). The mobile wallet transaction server can create a new mobile wallet transaction packet (compliant with IS8583) for each contributor (510). The mobile wallet transaction server can then send each new mobile wallet transaction packet to a respective issuer for payment processing (512).

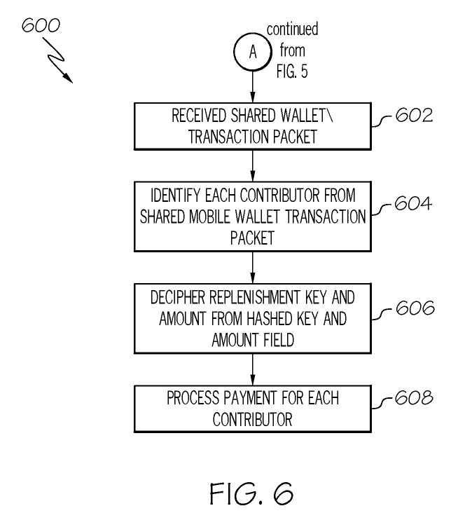

FIG. 6 is a process flow diagram 600 for a shared payment processor to process a shared mobile wallet transaction packet in accordance with embodiments of the present disclosure. The shared payment processor can be associated with the point of sale terminal (e.g., be a local or remote process server) or can be associated with an issuer. The shared processor can receive a shared mobile wallet transaction packet (602). For example, the shared payment processor can receive the shared mobile wallet transaction packet from an initiating mobile device (for payment processors associated with the PoS device) or from a PoS terminal (for payment processors associated with the issuer). The shared payment processor can process the shared mobile wallet transaction packet to identify each contributor making a mobile wallet transaction (604). The shared payment processor can decipher the hashed replenishment key and contribution amounts (606). The shared payment processor can then process payment (608).

### Example Embodiments

In embodiments, if the shared mobile wallet transaction packet sent by the initiating mobile device to the point-of-sale (PoS) device includes multiple separate transaction data, then the PoS device can combine the transactions into a single transaction string (e.g., as a shared mobile wallet transaction packet) that is sent to the issuer (e.g., via the payment server). The issuer server can be configured to interpret the shared mobile wallet transaction message and split the shared mobile wallet transaction packet into individual transactions for payment processing.

In embodiments, if the data in the shared mobile wallet transaction packet sent by the initiating mobile device to the PoS device is already formatted to a single transaction string, then the PoS device can work without modification. The PoS device can transmit the single transaction string (in an ISO8583 compliant packet, such as the shared mobile wallet transaction packet described herein) to an issuer. The issuer server can interpret this ISO8583 message as multiple individual transactions. The issuer can then process the individual transactions.

In embodiments, if the shared mobile wallet transaction packet sent by the mobile to PoS device has multiple separate transaction data, then the PoS device can make multiple payment transactions. That is, the PoS device can process each separate transaction by parsing the shared mobile wallet transaction packet and can send a mobile wallet transaction packet to a corresponding issuer (e.g., via a payment server). In this embodiment, the issuer can issue payment without augmenting the issuer processing.

In embodiments, if the shared mobile wallet transaction packet data sent by the mobile to the PoS device is formatted to a single transaction string, then the PoS device can be configured to interpret the shared mobile wallet transaction message and be configured to split the shared mobile wallet transaction packet into individual transactions. The PoS device can make multiple payment transactions directly by transmitting individual transaction packets to the corresponding issuer(s) through a payment server.

Near-field communication (NFC) is a set of communication protocols that enable two electronic devices, one of which is usually a portable device such as a smartphone, to establish communication by bringing them within 4 cm (1.6 in) of each other.

NFC devices are used in contactless payment systems, similar to those used in credit cards and electronic ticket smartcards and allow mobile payment to replace/supplement these systems. NFC is used for social networking, for sharing contacts, photos, videos or files. NFC-enabled devices can act as electronic identity documents and keycards. NFC offers a low-speed connection with simple setup that can be used to bootstrap more capable wireless connections.

NFC is a set of short-range wireless technologies, typically requiring a separation of 10 cm or less. NFC operates at 13.56 MHz on ISO/IEC 18000-3 air interface and at rates ranging from 106 kbit/s to 424 kbit/s. NFC always involves an initiator and a target; the initiator actively generates an RF field that can power a passive target. This enables NFC targets to take very simple form factors such as unpowered tags, stickers, key fobs, or cards. NFC peer-to-peer communication is possible, provided both devices are powered.

NFC tags contain data and are typically read-only, but may be writeable. They can be custom-encoded by their manufacturers or use NFC Forum specifications. The tags can securely store personal data such as debit and credit card information, loyalty program data, PINs and networking contacts, among other information. The NFC Forum defines four types of tags that provide different communication speeds and capabilities in terms of configurability, memory, security, data retention and write endurance. Tags currently offer between 96 and 4,096 bytes of memory.

As with proximity card technology, near-field communication uses magnetic induction between two loop antennas located within each other's near field, effectively forming an air-core transformer. It operates within the globally available and unlicensed radio frequency ISM band of 13.56 MHz. Most of the RF energy is concentrated in the allowed ±7 kHz bandwidth range, but the full spectral envelope may be as wide as 1.8 MHz when using ASK modulation.

Theoretical working distance with compact standard antennas: up to 20 cm (practical working distance of about 10 cm).

Supported data rates: 106, 112 or 424 kbit/s (the bit rate 848 kbit/s is not compliant with the standard ISO/IEC 18092)

The two modes are:

Passive—The initiator device provides a carrier field and the target device answers by modulating the existing field. In this mode, the target device may draw its operating power from the initiator-provided electromagnetic field, thus making the target device a transponder.

Active—Both initiator and target device communicate by alternately generating their own fields. A device deactivates its RF field while it is waiting for data. In this mode, both devices typically have power supplies.

A card-based transaction typically travels from a transaction acquiring device, such as a point-of-sale terminal or an automated teller machine (ATM), through a series of networks, to a card issuing system for authorization against the card holder's account. The transaction data contains information derived from the card (e.g., the account number), the terminal (e.g., the merchant number), the transaction (e.g., the amount), together with other data which may be generated dynamically or added by intervening systems. The card issuing system will either authorize or decline the transaction; and the card issuing system can then generate a response message that is delivered back to the PoS device terminal within a predefined time period.

ISO 8583 defines a message format and a communication flow so that different systems can exchange these transaction requests and responses. Many transactions made at ATMs use ISO 8583 packets at some point in the communication chain, as do transactions made when a customer uses a card to make a payment in a store (EFTPOS). In particular, both the MasterCard and Visa networks base their authorization communications on the ISO 8583 standard, as do many other institutions and networks. ISO 8583 has no routing information, so is sometimes used with a TPDU header.

Cardholder-originated transactions include purchase, withdrawal, deposit, refund, reversal, balance inquiry, payments and inter-account transfers. ISO 8583 also defines system-to-system messages for secure key exchanges, reconciliation of totals, and other administrative purposes.

Although ISO 8583 defines a common standard, it is not typically used directly by systems or networks. It defines many standard fields (data elements) which remain the same in all systems or networks, and leaves a few additional fields for passing network specific details. These fields are used by each network to adapt the standard for its own use with custom fields and custom usages.

The placements of fields in different versions of the standard varies; for example, the currency elements of the 1987 and 1993 versions are no longer used in the 2003 version, which holds currency as a sub-element of any financial amount element. As of writing, ISO 8583:2003 has yet to achieve wide acceptance.

An ISO 8583 message is made of the following parts:

Message type indicator (MTI)

One or more bitmaps, indicating which data elements are present

Data elements, the fields of the message

The International Standards Organization (ISO) defines and publishes data standards that are used by many organizations in the public and private sectors. A commonly used ISO standard for the banking and financial services sector is ISO8583. The ISO8583 standard is typically used by point-of-sale devices and automated teller machines. The ISO8583 messages themselves commonly contain information about the value of a transaction, where the transaction originated, the card account number, and bank sort code. The applications that data is sent to can have various purposes, such as transferring funds between bank accounts, paying bills, or purchasing mobile phone credit. You can use IBM® Integration Bus to transform data between the ISO8583 standard and more convenient formats such as XML, and by other protocols such as WebSphere® MQ, FTP, or HTTP.

ISO8583 messages can be preceded by a customized (often proprietary) header, but the core layout always contains the following sections:

Message Type Indicator (MTI)

The MTI consists of four numeric digits that specify the version of the ISO8583 standard, message class, message function, and message origin. Three versions of the standard exist: 1987, 1993, and 2003. The combination of the four MTI fields specifies the type of interchange message that is being transmitted. Typically, applications use the MTI to determine whether the message requires a response, and the format of the response:

The values to include in the MTI

The Message Data fields to include in the reply

One or more bitmaps

A message always includes a primary bitmap whose individual bits indicate which of the later fields are present in this particular message instance. The primary bitmap specifies whether fields 1-64 are present. If a secondary bitmap is also included, it specifies whether fields 65-128 exist. The standard also provides for a tertiary bitmap, which is rarely used. The bitmaps can appear in 8-byte ‘packed’ format or 16-byte ‘unpacked’ format.

Message Data Fields

Message Data fields are defined by the ISO8583 standard, and contain information about the transaction, such as amounts, dates, times, and country codes. Organizations that use ISO8583 often customize these fields.

What is claimed is:

1. A method performed on a mobile device for performing a shared mobile wallet transaction for a user and one or more shared mobile wallet contributors, the method comprising:
transmitting a shared mobile wallet transaction request message to a mobile device operated by a shared mobile wallet contributor across a network connection;
receiving, from the shared mobile wallet contributor, a wallet transaction packet, the wallet transaction packet comprising a monetary contribution value and an identifier of the shared mobile wallet contributor;
creating a shared mobile wallet transaction packet comprising a monetary contribution value for the user, an identifier of the user, the monetary contribution value for the shared mobile wallet contributor, and an identifier of the shared mobile wallet contributor; and
transmitting the shared mobile wallet transaction packet to a point of sale device across a communications link.

2. The method of claim 1, wherein transmitting the shared mobile wallet transaction packet to a point of sale device across a communications link comprises transmitting the shared mobile wallet transaction packet to the point of sale device across a near-field communication link.

3. The method of claim 1, wherein the received mobile wallet transaction packet further comprises a replenishment key associated with the shared mobile wallet contributor and a hash of the monetary contribution value for the shared mobile wallet contributor and the replenishment key.

4. The method of claim 1, wherein the received mobile wallet transaction packet further comprises banking information associated with the shared mobile wallet contributor.

5. The method of claim 1, wherein the shared mobile wallet transaction packet comprises an International Organization for Standardization (ISO) 8583 compliant packet.

6. The method of claim 1, further comprising:
identifying the one or more shared mobile wallet contributors from a contacts list on the mobile device;
and wherein transmitting a shared mobile wallet transaction request message to a mobile device operated by a shared mobile wallet contributor across a network connection comprises transmitting the shared mobile wallet transaction request to one or more shared mobile wallet contributors from the contacts list.

7. The method of claim 1, wherein receiving, from the shared mobile wallet contributor, a wallet transaction packet, the wallet transaction packet comprising a monetary contribution value and an identifier of the shared mobile wallet contributor comprises receiving the wallet transaction packet from across a near-field communication link.

8. The method of claim 7, wherein the receiving, from the shared mobile wallet contributor, a wallet transaction packet, the wallet transaction packet comprising a monetary contribution value and an identifier of the shared mobile wallet contributor comprises receiving the wallet transaction packet from across a network connection.

9. A computer program product comprising a computer readable storage medium comprising computer readable program code embodied therewith, the computer readable program code comprising:
computer readable program code configured to broadcast, from an initiating mobile device, a shared mobile wallet transaction request message to a contributing mobile device;
computer readable program code configured to receive from the contributing mobile device a mobile wallet transaction message comprising a transaction amount and an identifier of a user of the contributing mobile device; and
computer readable program code configured to create a shared mobile wallet transaction message comprising a transaction amount and identifier for a user of the initiating mobile device and the transaction amount and identifier of the user of the contributing mobile device; and
computer readable program code configured to transmit the shared mobile wallet transaction message to a point of sale device across a near-field communications link.

10. The computer program product of claim 9, computer readable program code configured to create a shared mobile wallet transaction message further comprises computer readable program code to add a replenishment key associated with the contributing mobile device and a hash of the transaction amount and the replenishment key for the contributing mobile device to the shared mobile wallet transaction message.

11. The computer program product of claim 9, wherein the received wallet transaction message further comprises banking information associated with the shared mobile wallet contributor.

12. The computer program product of claim 9, wherein the shared mobile wallet transaction message comprises an International Organization for Standardization (ISO) 8583 compliant packet.

13. The computer program product of claim 9, further comprising:
computer readable program code configured to identifying the one or more shared mobile wallet contributors from a contacts list on the mobile device;
and wherein computer readable program code configured to transmit a shared mobile wallet transaction request message to the contributing mobile device op across a network connection comprises computer readable program code configured to transmit the shared mobile wallet transaction request to one or more contributing mobile devices from the contacts list.

14. The computer program product of claim 9, wherein computer readable program code configured to receive a mobile wallet transaction packet from the contributing mobile device comprises computer readable program code to receive the mobile wallet transaction packet from across a near-field communication link.

15. The computer program product of claim 9, wherein computer readable program code configured to receive a mobile wallet transaction packet from the contributing mobile device comprises computer readable program code to receive the mobile wallet transaction packet from across a network connection.

16. A method performed on a mobile wallet transaction server, the method comprising:
receiving, from a point of sale device, a shared mobile wallet transaction packet comprising a monetary contribution value for a plurality of mobile wallet transaction contributors and an identifier of each mobile wallet transaction contributor;
identifying, from the shared mobile wallet transaction packet, a first mobile wallet transaction contributor and a monetary contribution value for the first mobile wallet transaction contributor;
identifying from the shared mobile wallet transaction packet a second mobile wallet transaction contributor and a monetary contribution value for the second mobile wallet transaction contributor;
transmitting a mobile wallet payment request comprising the monetary contribution value to a payment processing server for the first mobile wallet transaction contributor; and
transmitting a mobile wallet payment request comprising the monetary contribution value to a payment processing server for the second mobile wallet transaction contributor.

17. The method of claim 16, further comprising determining that the mobile wallet payment processor for the first mobile wallet transaction contributor and the payment processing server for the second mobile wallet transaction contributor are the same payment processing server; and transmitting the shared mobile wallet transaction packet to the same payment processing server.

18. The method of claim 16, wherein receiving, from a mobile device, a shared mobile wallet transaction packet comprises receiving, from a mobile device, a shared mobile wallet transaction packet from a near field communications link.

19. The method of claim 16, wherein identifying the first mobile wallet transaction contributor comprises identifying banking information for the first mobile wallet transaction contributor and identifying a payment processing server associated with the banking information.

20. The method of claim 16, wherein the shared mobile wallet transaction packet is compliant with an ISO8583 standard.

21. The method of claim 16, further comprising transmitting to a payment processing server an MD5 hash of the first mobile wallet transaction contributor and a monetary contribution value.
